(19) United States
(12) Patent Application Publication
(10) Pub. No.: US 2010/0306071 A1
(43) Pub. Date: Dec. 2, 2010

(54) Method to transfer sales tax in real time from point of sale to a collecting government agency

(76) Inventor: James E. Kay, St. Peters, MO (US)

Correspondence Address: Paul M. Denk, 763 South New Ballas Rd., Ste. 305, St. Louis, MO, 63141, US

(21) Appl. No.: 12/802,048

(22) Filed: May 28, 2010

Related U.S. Application Data
(60) Provisional application No. 61/183,005, filed on Jun. 1, 2009.

(51) Int. Cl. G06Q 40/00; G06Q 30/00

(52) U.S. Cl. 705/19

(57) ABSTRACT

A method begins when a merchant sells to a retail consumer. The consumer then pays the merchant by credit card or debit card. The terminal of the merchant collects the sales data and transmits the sales data to a processor along with the sales revenue. The processor determines the geographic location of the merchant or the customer and the type of goods and services purchased, and then refers to an electronic table of tax rates by taxing authority. The processor then calculates the appropriate sales taxes and its commission upon a computer system. The processor then divides the sales taxes and commission from the sales revenue from immediate deposit to a collecting government agency and the merchant respectively. The method collects sales data upon the terminal or keypad of the merchant at the point of sale.

### CROSS REFERENCE TO RELATED APPLICATION

This non-provisional application claims priority to the pending provisional patent application Ser. No. 61/183,005 which was filed on Jun. 1, 2009 and is owned by the same inventor.

### BACKGROUND OF THE INVENTION

This business method relates to tracking retail purchase transactions generally and more particularly relates to segregating sales taxes from sales revenue in real time for immediate deposit. The method of the present invention seeks to automate both the collection and remittance of sales taxes from credit card transactions.

Presently, collecting government agencies, primarily state departments of revenue, receive sales taxes imposed by statute, such as R.S.Mo. 144. The statutes permit merchants to pay such sales taxes monthly, quarterly, or even annually, whether fiscal or calendar.

Current processes and practices of collecting sales taxes suffer from inefficiency and ineffectiveness. Current processes call for intense use of resources, such as people and equipment, at the merchant and collecting government agency levels. The current processes overly rely upon manual, often paper, filing of reports. Current practices hamper effectiveness by allowing significant float, that is, up to 60 days, between collection of sales taxes and their deposit with the collecting government agency. Further the current practices permit proliferation of collection costs and losses because of fraud and bankruptcy. Estimates for Missouri, a middle size state, put such losses in excess of $100 million annually. Viewing the resources, labor, float, and losses, collecting government agencies, such as states, have a significant incentive for automating sales tax collection, more particularly, the deposit of sales taxes. Missouri officials have indicated their existing processes had automated reporting and deposit of sales taxes however, such has not happened to date. Reducing the float will improve the cash flow for the state and aid in meeting revenue goals during tougher economic times.

In brief, current sales tax collection processes begin with a sale of goods or services at a point of sale where the buyer pays by credit card or debit card. The processor then receives the sales transaction information including the sales taxes. At the end of each business day, the merchant receives the sales revenue and sales taxes less processor fees and commission in the merchant bank account. The merchant's bank account then holds the principal amount of the sale and the liability for sales tax on that sale. The merchant then prepares a sales tax report to the collecting government agency, here a state. The state provides an incentive to merchants, of 2% discount. Outside of that incentive, the sales taxes and report are due to the state within thirty days of the sale and without any discount.

A business method, upon a sale paid for by a credit or debit card, has a credit card processing company that sends the sales tax collected directly to the applicable taxing authority's bank account. Unlike a payment system on a monthly, quarterly, or annual interval, the present invention allows for payment of sales taxes to the collecting government agency within days of a sale, much sooner than the current system. The present invention reduces the need to research up to ninety day old sales information for calculation of sales tax reports. The method of the present invention applies to transactions in a single state or in multiple states of the United States of America. The method of the present invention makes filing of state sales tax returns quicker and easier.

The method of the present invention also eliminates sloppy recordkeeping and fraud occasionally caused by merchants utilizing the sales tax funds kept by the merchant as a fiduciary for the collecting government agency. The method of the present invention collects sales taxes and deposits the sales tax amount within twenty four hours with the collecting government agency so that a merchant need not hold those funds long, thus minimizing the risk of improper use of the sale tax funds. A merchant would no longer have possession of the sales tax funds until submission of a report, often up to thirty days, a significant time for interest on float to accumulate.

The present invention lessens the potential for fraud by having the sales tax funds remitted to the appropriate collecting government agency in real time without waiting for a merchant to file a sales tax report and remit the funds with the report. The present invention also eliminates the collecting government agency's legal expenses in prosecution of felony charges and fraud convictions for merchants that fail to report sales taxes collected but not remitted to the collecting government agency. Further, the present invention eliminates the loss of sales taxes when the collecting government agency and merchant agree upon a plea bargain. Such a plea bargain occurs when a business defaults and has no funds to remit to the state. Then the collecting government agency must either prosecute the business leading to a fine or settle for a lesser amount, commonly known as a plea bargain, often settling at 10% of the disputed amount. Because the present invention allows for collecting the sales taxes at the time of the credit card/debit card transaction, the entire amount of sales tax due is transmitted directly to the state bank account.

The total lost revenue to the collecting government agencies because of nonpayment of sales tax from fraud and business failure is an aggregate of $700 million. Multiply this estimate by forty nine other states, and other collecting government agencies, and the national savings accumulate significantly. The collecting government agencies, often states, would realize an increase in collectible funds of over $100 million annually. Because of the real time collection of sales taxes, the increase in cash flow for a collecting government agency can be substantial. And further, the present invention has savings in productivity and natural resources. For example, the merchants and the collecting government agencies save time and labor because the process of reporting and reconciliation has a more streamlined form through the present invention. The present invention provides merchants with less frequent reporting periods regarding sales that utilize debit card or credit card for payment. And, collecting government agencies, such as states, save in the time, labor, and paper to receive and process reports. Rough estimates indicate that the present invention will save thousands of reams of paper annually for each collecting government agency.

### DESCRIPTION OF THE PRIOR ART

For nearly a century, retail merchants, or those merchants who sell to end users, have had imposed upon them the obligation to collect and to remit sales taxes to a collecting government agency. The merchants generally apply the sales tax rate to the final total sale price of the items or services purchased by the consumer. The consumer identifies this tax as the last item upon a receipt. The merchants then collect the sales taxes, assemble a report, and then remit the sales taxes, or use taxes, less a processing fee to the collecting government agency.

Present day sales tax collection methods involve the sales amount collected plus sales tax being added together as a total sum. The total sum is then deposited into the merchant's bank account by the credit card processing company. Further, the merchant's bank receives the total transaction amount less fees paid to the credit card processing company. This fee includes a transaction fee plus a percentage of the total sale. The merchant must then file a periodic report and remit the sales tax amount collected to the collecting government agency.

With people operating businesses as merchants, a merchant may default and fail to remit the sales taxes and use taxes to the collecting government agency for a number of reasons. A merchant may not have the funds to remit the sales taxes because it used those funds for other expenses. A merchant may go out of business, particularly during recessions and other economic slowdowns. A merchant, or an agent of a merchant, may commit fraud by intentionally failing to remit the actual sales taxes collected. Because of these reasons, collecting government agencies lose large amounts of sales tax revenue. As an example, the state of Missouri does not collect over $100 million annually for the above reasons. Expand the example to all 50 states and other collecting government agencies and the total losses accumulate into the billions of dollars.

Collecting government agencies also have a decrease in their cash flow because of discounts provided to merchants for collection and reporting sales taxes. The discount, usually a percentage of sales taxes collected by the merchant, provides an incentive for the merchant to report and to pay quickly the sales tax due to the collecting government agency. For example, in Missouri, the department of revenue allows a 2% discount if the merchant remits the sales tax when due. Though merchants benefit from a discount, the collecting government agency loses some sales tax revenue.

U.S. Pat. No. 7,188,083 to Agee et al. describes a system and method to rapidly collect and distribute taxes, particularly sales taxes and merchant income taxes. This method has collection of taxes at point of sale and regular distribution of sales taxes. This method also has centralized distribution between merchants and taxing authorities. This method operates on an exchange of signals. However, this method does not disclose transmitting the merchant's location at the time of the sale and location specific determination of the sales tax rate assessed on any such purchases.

Then, U.S. Pat. No. 6,993,502 to Gryglewicz et al. describes computation and collection of sales taxes within legal guidelines of a national government. This method operates between customer computers, merchant computers, merchant bank computers, and taxing authority computers. This method has a control system for communicating between the various computers previously described. However, this method does not disclose capturing sales information at a retail location and has limited disclosure of tax calculations.

The patent publication to Brown, U.S. pub. no. 2004/0193540 provides a method that impounds funds from a merchant electronically into an escrow account for later use as in sales tax remittances. A processor from time to time checks the status of an escrow account. Then the processor periodically disburses funds from the escrow account and reports to the merchant. This method operates upon determining two sales amounts and crediting the difference between them to the escrow account. However, this Brown publication does not disclose customer or merchant address information for determination of taxing jurisdiction. This Brown publication also explains that the processor pays the funds directly to the merchant without any portion of the funds distributed to a collecting government agency.

The present invention overcomes the disadvantages of the prior art and provides a method to collect and remit sales taxes from the point of sale directly to the collecting government agency in real time. The method provides the precise geographic location of the point of sale to a processor that determines the appropriate tax rate for taxing authority. The method also provides to a processor the type of goods purchased during a sale segregated by the merchant for use by the processor in determining the appropriate tax by goods and services. From that information, the method segregates sales tax revenue of each retail sale from the total purchase price. The method avoids the merchant holding sales taxes and deposits the sales taxes directly with collecting government agency. Merchants, electronic payment processors, and collecting government agencies operate the method of the present invention with limited modification to existing terminals and networks.

### SUMMARY OF THE INVENTION

Generally, the present invention is a method of segregating sales taxes from a retail purchase at time of purchase, calculating sales taxes due, and remitting the sales taxes directly to the collecting government agency and net revenue to a merchant within less than two business days. A customer purchases one or more items at a retail location. The customer then pays for the purchase, more often with electronic payments such as by credit card or debit card. The card number is then entered into a terminal by swiping the magnetic stripe upon a reader or keying the card number into the terminal. The terminal then matches the card number to the purchase price. From the data at the terminal, a credit card processing company has the sales taxes collected and then transmits the sales taxes via electronic networks directly to the collecting government agency's accounts and reporting system.

Following a sale where a customer pays by credit card or debit card to a merchant, a processor then receives the sales information including the sales amount and sales taxes. The present invention then calculates the sales taxes due from the information at the processor. The processor then disburses the principal amount of the sale less processor fees and commission to the bank account of the merchant and the sales taxes to the bank account of the collecting government agency within less than two business days.

The method of the invention allows a financial institution, or credit card processing company, to segregate the sales amount, the sales tax amount, tips, and other amounts as needed or required by the merchant, the credit card processing company or the collecting government agency. The credit card processing company then sends just the sales amount plus applicable tips less transaction fees and commission to the merchant's bank account. At the same time, the credit card company remits the collecting government agency's sales taxes collected directly to the agency's bank accounts.

The method of the invention has these primary features. First, a sale occurs and the customer pays by electronic payment, such as a credit or debit card, or in the declining alternative of cash or check. The sale amount includes the price for the merchandise or service, sales taxes due to the collecting government agency and any other charges, such as tips in a restaurant. Hereinafter, this sale amount is the Total Credit/Debit Card Sale, “TCDCS.” The invention then transmits the TCDCS as a total sale amount and sales tax amount. This transmission generally programs into the merchant's terminal, POS terminal, register computer, and like equipment similar to actual sales tax calculations upon existing computers, terminals, and equipment. If a merchant does not have a computer, then the merchant can manually enter each sale amount into the present invention.

Second, the present invention transmits the TCDCS to the credit card processor for approval. When the processor approves the TCDCS transaction, then the merchant concludes the transaction with the consumer. Meanwhile, the credit card processor receives the data of a split transaction of total sale amount and sales tax amount.

Third, at the end of one business day from the sale to the consumer, the merchant receives the sales transaction amount of funds and the collecting government agency, or state, receives the sales tax funds. In a typical arrangement, the merchant receives the TCDCS amount less the credit card processor fees and the sales taxes imposed. Because the credit card processor segregates the sale amount and the sales tax amount, the merchant pays processing fees on only the sale amount, thus paying a lesser commission to the credit card processor. However, the collecting government agency allows the credit card processor to collect a commission, usually a percentage, for processing the sales tax amounts for direct remission to the collecting government agency. This commission incentivizes the credit card processor to process the sales tax transaction pursuant to this invention. The merchant will no longer participate in sending the sales taxes to the collecting government agency.

Additionally, the processor generates a reconciliation report of the credit card and debit card transactions that it has processed along with the sales revenue and the sales taxes. The processor then provides the reconciliation report to the merchant who submits the reconciliation report about the credit card and debit card transactions, sales, and sales taxes to the collecting government agency, or state, at a quarterly interval. Upon further deployment and familiarization of the invention into the merchant community, the merchants may submit the reconciliation report about the credit card and debit card transactions on a semi-annual, annual, or longer interval. However, merchants that continue to accept cash, checks, and cash equivalents will still submit their sales tax reports each month to the state or collecting government agency.

The collecting government agencies, or states, have incentives to implement this invention, as referred to above. Further, the collecting government agencies have their inherent legislative authority to order merchants to implement this invention. The collecting government agencies also have much to gain from implementing this invention because the state currently pays an incentive for merchants to remit sales taxes, 2% of the sales tax collected, in Missouri. The present invention removes the percentage discount provided from the state to the merchants.

Merchants have incentives to implement this method of collecting sales taxes. The present invention shifts the burden of collecting, remitting, and reporting sales taxes from the merchant to the credit card processor. The merchant no longer pays a credit card processing commission upon the sales taxes.

The credit card processors also have their incentives for adopting the present invention. The processors receive a fee, usually a percentage commission, upon the sales taxes collected and remitted to the collecting government agency. The processors also retain their commission upon each sale amount between consumer and merchant. The processors can also charge a fee to the collecting government agency for their service and rapid deposit of sales tax funds.

Though each party has an incentive to adopt and to deploy the present invention, all of the credit card processors will have to agree to adopt the invention. A mandate from primary collecting government agencies, such as each state's department of revenue, can ease the adoption of legislation which provides for the integration of the present invention by merchants and processors.

There has thus been outlined, rather broadly, the more important features of the invention in order that the detailed description thereof that follows may be better understood and that the present contribution to the art may be better appreciated. Additional features of the invention will be described hereinafter and which will form the subject matter of the claims attached.

Numerous objects, features and advantages of the present invention will be readily apparent to those of ordinary skill in the art upon a reading of the following detailed description of the presently preferred, but nonetheless illustrative, embodiment of the present invention when taken in conjunction with the accompanying drawings. Before explaining the current embodiment of the invention in detail, it is to be understood that the invention is not limited in its application to the details of construction and to the arrangements of the components set forth in the following description or illustrated in the drawings. The invention is capable of other embodiments and of being practiced and carried out in various ways. Also, the phraseology and terminology employed herein are for the purpose of description and should not be regarded as limiting.

One object of the segregating and real time depositing of sales taxes method is to remit sales taxes within one day of a sale to the collecting government agency.

Another object of the segregating and real time depositing of sales taxes method is to eliminate fraud by merchants and businesses during and after a to sales transaction and when business merchant defaults or enters bankruptcy.

Another object of the segregating and real time depositing of sales taxes method is to provide separate deposits of sales taxes and sales revenue to collecting government agencies and merchants respectively.

Another object of the segregating and real time depositing of sales taxes method is to provide such a method that has a low cost of development, implementation, and deployment so the merchants, financial institutions, and credit card processors can readily purchase the method through existing suppliers.

These together with other objects of the invention, along with the various features of novelty that characterize the invention, are pointed out with particularity in the claims annexed to and forming a part of this disclosure. For a better understanding of the invention, its operating advantages and the specific objects attained by its uses, reference should be had to the accompanying drawings and descriptive matter in which there is illustrated a preferred embodiment of the invention.

### BRIEF DESCRIPTION OF THE DRAWINGS

In referring to the drawings,

FIG. 1 shows a block diagram of the method of the present invention for multiple species of payment; and,

FIG. 2 shows a block diagram of the method of the present invention for credit card and debit card payment.

The same reference numerals refer to the same parts throughout the various figures.

### DESCRIPTION OF THE PREFERRED EMBODIMENT

The present invention overcomes the prior art limitations by providing a real time depositing of sales taxes method that readily separates, or divides, sales taxes from sales amounts for remitting and deposit within one day of a sale transaction.

Presently, various financial researchers have estimated cash and cash equivalent payments as about 15% of total payments for retail sales transactions in a state. Such a payment stream is handled by the present invention primarily after deposit of the funds into a financial institution. The financial institution operates similar to the previously described credit card processor in segregating sales tax funds and remitting them to the collecting government agency in real time.

In the event a merchant, or a credit card processor, elects to remain in the existing sales tax collecting, reporting, and remitting system, the merchant retains the obligation to remit sales taxes from cash and cash equivalent sales. The merchant then deposits the purchase amounts from each sale into the merchant's account at a financial institution. If a merchant deposits solely purchase amounts into a specific account, the merchant readily reports and remits sales taxes to the collecting government agency. A financial institution holding the merchant's funds may then remit the sales taxes collected directly to the collecting government agency.

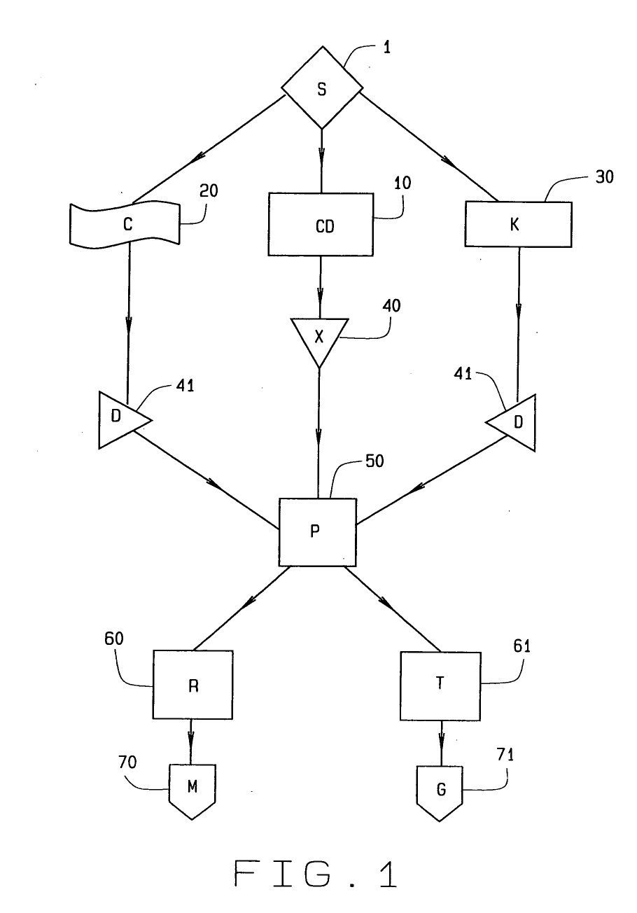

An alternate relationship among the steps that constitute the present invention appears in the block diagram of FIG. 1. The method begins at the retail sale S of a good or service, as at 1, with a payment for the good or service by a credit card or a debit card CD, as at 10, or alternatively by cash C as at 20 or check K as at 30, at the location of the sale, preferably the merchant's location. Upon completion of the sale, the consumer receives the goods or services. Next, the electronic payment data for a credit or debit card transmits immediately upon acceptable electronic networks, X, to the credit card processor, as at 40. The electronic payment data includes the merchant identification number provided by the processor, the state merchant identification number provided by the state sales tax authority, and the location of the sale. These two steps occur in sequence because the merchant computer or terminal electronically captures and transmits the electronic data of the sales transaction. Once the data has been collected by the merchant and transmitted to the credit card processor, P, as at 50, the data can be transmitted to each collecting government agency that has requested the sales data. When a retail sale has occurred, as at 1, the sale has a tax imposed and the resulting sales tax revenue becomes the funds of the collecting government agency, often a state. The merchant through the credit card processor remits the sales tax funds. When in electronic form, the sales tax funds transmit readily by the present invention between merchants and credit card processors. The present invention can operate upon various configurations of the merchant's computer, a card reader, or a terminal as is typically seen at retail sale locations. Further, the present invention operates between the financial institutions, such as banks, of the credit card processor, the merchant, and the collecting government agency or state.

As shown in FIG. 1, the steps follow a defined sequence with minimal alternative decisions or paths to follow. A merchant has its decision making limited to whether a transaction is an electronic transaction by a credit card or a debit card or by cash or cash equivalent, requiring a deposit of the actual species of currency, checks, and a deposit slip in a financial institution. Though electronic payments have eclipsed cash and check payments in number and volume, the present invention, in an alternative embodiment, provides an accommodation for those forms of payment. In an alternate embodiment, for a cash transaction, the present invention provides a merchant identification card, generally related to the state sales tax number. After completing a business day, a merchant assembles its cash and checks for deposit into the merchant's financial institution, or bank. The deposit includes a paper deposit slip that identifies the total deposit. With the deposit prepared, the merchant swipes its merchant identification card upon a reader, similar to an ATM machine. The reader then assigns the deposit amount to the merchant's identification member. The reader then transmits the deposit amount and merchant identification number further along into the present invention for processing similar to that of credit/debit card transactions. With the information about a sale and the merchant, the present invention then determines the sales taxes applicable from the deposited amount, segregates the sales tax funds T and remits them to the collecting government agency G promptly, as at 71.

FIG. 1 also shows that eliminating steps in tracking and reporting the sales taxes from a cash equivalent transaction, as in the present invention, results in substantial savings to the merchant in compiling sales tax reports and remittances for those transactions. These savings more than offset the costs of deploying the present invention upon the computers of merchants, credit card processors, and collecting government agencies. FIG. 1 shows the operations of the present invention as straightforward and direct.

Upon making a sale, a retail cashier enters the data about the sale into the merchant's computer system by a bar code scanner or manually. In that computer system, the sales data undergoes analysis and calculation for management and tax purposes. The present invention, deployed upon a merchant's computer system calculates the sales tax due upon a sale and transmits the information over a network, as at 40, the sales tax amount to the credit card processor P, as at 50. The credit card processor then segregates the sales taxes T, as at 61, from the sales revenue R, as at 60, for remittance to the collecting government agency G, as at 71, and for deposit to the merchant M, as at 70, respectively. Where a merchant uses a computer system, the present invention operates automatically to calculate and segregate sales taxes. If a merchant has a manual sales system, the present invention operates once a merchant enters sales data through a keypad, terminal, reader, or computer.

After entry of the total sales amount, the credit card processor receives the sale amount and sales tax amount as items of data tied to each purchase transaction. The sales amount arrives at the credit card processor from the merchant's computer less any transaction fees, refunds, and the like. The sales amount includes the discount paid under the prior art method to the merchants, about 2% to about 3% as described above. The sales tax amount also arrives at the bank account of the collecting government agency or state along with the corresponding merchant sales tax identification number provided by the agency using existing procedures.

The method of the present invention streamlines the collection, reporting, and remitting of sales taxes. The present invention allows for input of a sales amount one time that leads to collection, reporting, and remitting of sales taxes without additional entries of sales information. The merchant produces a register receipt, or saves a ticket at the point of sale. Upon entry of this sale into a computerized register, the computer calculates the sales tax for a collecting government agency based upon rate tables loaded into the computer and upon the type of merchant, merchandise, service, and location. For example, Missouri has different tax rates for staple foods, non-staple foods, and hardware such as retail building materials. These rates often have a tiered, or hi/lo, rate structure but lend themselves readily for programming into a merchant's computer system for automatic calculation of the various hi and lo taxes and the total sales tax.

The present invention's method captures the streams of data from the point of sale and the merchant's computer system upon their input into the computer system and thus allows for electronic transmission to the collecting government agency as directed by the various revenue statutes and ordinances in effect upon a merchant. The present invention allows for direct remittance of sales tax funds to the collecting government agency, saving the merchant from the toil of compiling a sales tax collection report and remitting the sales tax funds under the existing system.

As described above, the present invention also allows for cash payment at a sale while computing the sales taxes due from a deposit slip received at a financial institution. The present invention also operates upon cash equivalents such as checks submitted for payment at a sale. Upon presentation of a check at a sale, the merchant accepts the check for the amount of purchase and deposits it into a merchant's account with a merchant identification card as described above. The present invention guides the merchant to deposit checks from retail sales into a designated account. Amounts in the designated account are then processed by the invention as at 50 into a sales amount R, as at 60 and a sales tax amount T, as at 61. The financial institution then transfers the sales tax amount directly to the collecting government agency G as at 71.

Presently, many collecting government agencies struggle with collecting sales taxes upon online purchases, such as those completed over websites and the Internet. The method of the present invention lends itself readily to online and Internet sales because it operates through the same credit card processors used by Internet merchants. As an example, PayPal® processes sales transactions nationwide for both merchants and individuals.

For years, collecting government agencies have imposed and collected sales taxes on mail order sales, usually based upon the buyer's location, or shipping address. The method of the present invention may determine the collecting government agency from the shipping address in a mail order and segregate the sales taxes from sales amount from the buyer's mailed payment, whether, check, credit card, or debit card.

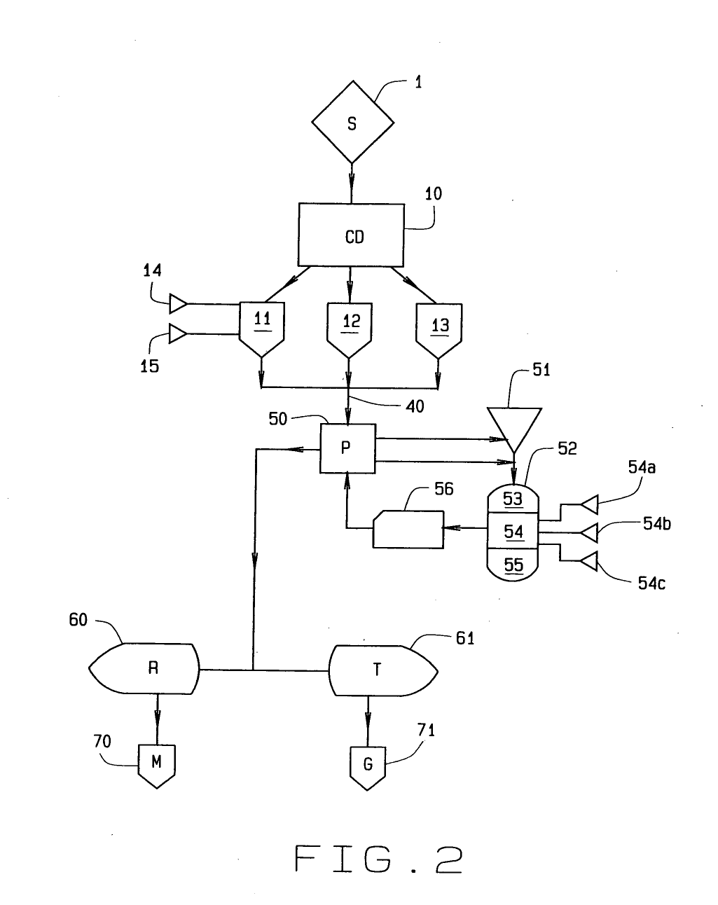

Preferably, the method of the present invention operates exclusively upon credit card and debit card transactions as shown in FIG. 2. Upon completion of a sale S as at 1, a customer elects to pay by credit card or debit card as at 10. Either the customer or the merchant then enters the credit card or debit card number and expiration date into the merchant's computer system for verification. Once the number and expiration date receive verification, the merchant then provides the goods or services to the customer. The merchant's computer then marshals certain information from the sales transaction for use by the present invention. The present invention utilizes the merchant name 14 and merchant location 15 contained within a merchant identification number as at 11, the type of goods and services purchased 12, and the dollar amount of the sale, as at 13. The type of goods and services purchased includes low tax goods, such as food staples, medium tax goods, and high tax goods, such as non-essential foods and beauty aids. The merchant's computer transmits this certain information over electronic networks 40 to the processor P as at 50.

The processor P then utilizes the certain information along with the present invention to determine the sales taxes due. The method of the present invention determines the location of the sale, as at 51. The method identifies the merchant name 14 and the merchant's location 15 as provided from the merchant's computer. The method then cross references the merchant's location, or geographic position, with a table identifying the tax rates applicable to the merchant's location, or geographic position. This location and tax rate table has periodic revisions when rates or boundaries of taxing authorities change. The location and tax rate table refers to merchant locations by at least zip code level. The processor and the collecting government agencies, primarily states, will communicate from time to time for the purpose of updating rate tables. In an alternate embodiment, the location and tax rate table utilizes the latitude and longitude of the merchant location and compares it to the boundaries of taxing authorities. In the alternate embodiment, the present invention then determines whether the merchant location falls within a boundary of a certain taxing authority. In a further alternate embodiment, the present invention utilizes address and map databases so that the present invention determines the map location of a merchant for a given address. The present invention then compares the map location of a merchant to the boundaries of a taxing district.

With the increase in online commerce, merchant and customer may have a large separation across multiple taxing authorities. The present invention utilizes the merchant information 14, 15 and can also use customer information such as billing address. The present invention also cross references the customer's location to a table identifying the tax rates applicable to the customer's location. From this information, the present invention calculates a use tax applicable to the customer.

Having determined the merchant location as in 51, the present invention then calculates the sales taxes due. The present invention references a table of tax rates, as at 52, primarily dependent upon location 53. If the location identifies a taxing authority that imposes taxes on goods, as at 54, at various levels, the present invention consults a table that identifies the tax rate applicable to a good. Such rates often appear as high 54a, medium, 54b, and low 54c. The present invention utilizes the type of goods purchased 12 and references that to a rate table. For example, select states have imposed a lesser tax rate, 54c, upon necessary grocery goods, typically staples such as flour, produce, and milk and a higher tax rate upon beauty aids, charcoal, and other general merchandise. The present invention compares the type of goods 12 in a transaction to the tax rate table loaded upon the processor's computer, or computer system, and selects the applicable rate. In states that impose a sales tax upon services, as at 55, the present invention once again refers to the type of services purchases, also as at 12, and compares the services to a tax rate table and selects the pertinent rate.

Having determined the merchant, the customer, the location of the merchant and the location of the customer, the present invention selects a sales tax rate as described above. Upon a computer, as at 56, generally with the processor P as at 50, the present invention calculates the sales taxes due from a transaction by multiplying the sales amount, segregated by type of goods and services, by the applicable sales tax rate. The present invention then divides the total sales amount into sales revenue 60 and sales taxes 61. The processor P then deposits the sales revenue as at 70 into the merchant's bank account M and the sales taxes as at 71 into the collecting government agency's account G. These deposits of funds from a divided revenue stream take place in less than two business days or forty eight hours. Alternatively, the processor deposits the sales taxes with the collecting government agency and the sales revenue with the merchant within twenty four hours. In a further alternative embodiment, the processor deposits the sales taxes and the sale revenue with their respective recipients within eight hours.

In time, federal statutes, such as Federal Reserve regulations, will direct credit card processors and financial institutions to report credit card sales. When these regulations take effect, the credit card processors will segregate the sales taxes from the purchase amount before release of funds to the participating merchant.

From the aforementioned description, a method to transfer sales tax in real time from point of sale to a collecting government agency has been described. The method is uniquely capable of segregating sales taxes from sales amounts at the time of a retail sale. The method then guides a financial institution to deposit the sales tax funds with a collecting government agency and the sales funds with a merchant in real time. The method and its various components may be deployed upon various computer systems from point of sale terminals, readers, and keypads to personal computers, servers, server farms, mini-computers, micro-computers, main frames, and the like.

As such, those skilled in the art will appreciate that the conception, upon which this disclosure is based, may readily be utilized as a basis for the designing of other structures, methods and systems for carrying out the several purposes of the present invention. Heretofore, those skilled in the art have not recognized a real-time segregation of sales taxes from sales revenue for deposit with a collecting government agency and a merchant respectively. Therefore, the claims include such equivalent constructions insofar as they do not depart from the spirit and the scope of the present invention.

I claim:

1. A method for dividing sales taxes from sales revenue of a retail sale between a customer and a merchant for deposit with a collecting government agency and a merchant in real time, a processor operating between the merchant and the collecting government agency, comprising:
collecting retail sales information and sales revenue at a point of sale upon a terminal, said retail sales information including merchant name, merchant location, customer name, customer location, type of goods purchased, type of services purchased, tips, and form of payment;
assembling said retail sales information from a plurality of terminals of a merchant;
transmitting said retail sales information and said sales revenue from said plurality of merchant terminals to a processor via an electronic network;
determining a geographic position of one of a merchant and a customer upon a computer system of said processor;
selecting a tax rate from said geographic position out of an electronic table of geographic tax rates upon the computer system of said processor;
calculating sales taxes due using a selected tax rate applied to said retail sales information upon the computer system of said processor;
dividing sales taxes from sales revenue upon the computer system of said processor; and,
depositing sales taxes with a collecting government agency and sales revenue with said merchant by the computer system of said processor in a timely manner.

2. The method of dividing sales taxes from sales revenue of claim 1 further comprising:
said selecting a tax rate identifying the type of goods purchased at a retail sale, then further selecting a tax rate from said type of goods from an electronic table of type of goods tax rates upon the computer system of said processor.

3. The method of dividing sales taxes from sales revenue of claim 1 further comprising:
said selecting a tax rate identifying the type of service purchased at a retail sale, then further selecting a tax rate from said type of service from an electronic table of type of service tax rates upon the computer system of said processor.

4. The method of dividing sales taxes from sales revenue of claim 1 further comprising:
said calculating sales taxes excluding tips.

5. The method of dividing sales taxes from sales revenue of claim 1 wherein said collecting retail sales information includes form of payment being one of credit card and debit card.

6. The method of dividing sales taxes from sales revenue of claim 1 further comprising:
said calculating sales taxes due further calculating a commission due said processor;
said depositing sales taxes further depositing sales revenue with a merchant less the commission due said processor.

7. The method of dividing sales taxes from sales revenue of claim 1 wherein said depositing sales taxes with a collecting government agency and sales revenue with said merchant occurs within forty eight hours of a retail sale.

8. The method of dividing sales taxes from sales revenue of claim 7 wherein said depositing sales taxes with a collecting government agency and sales revenue with said merchant occurs within twenty four hours of a retail sale.

9. The method of dividing sales taxes from sales revenue of claim 7 wherein said depositing sales taxes with a collecting government agency and sales revenue with said merchant occurs within eight hours of a retail sale.

10. A method of entering sales and sales tax information upon a sale between a customer and a merchant and dividing sales taxes from sales revenue for real time deposit with a collecting government agency and the merchant, further comprising:
collecting retail sales information and sales revenue at a point of sale, said retail sales information including merchant name, merchant location, customer name, customer location, type of goods purchased, type of services purchased, tips, and form of payment being one of credit card or debit card;
assembling retail sales information from a plurality of terminals of a merchant;
determining a geographic position of one of a merchant and a customer upon a computer system of said processor;
selecting a tax rate from said geographic position from an electronic table of position tax rates upon the computer system of said processor, identifying the types of goods and services purchased at a retail sale, and then further selecting a tax rate from said types of goods and services purchased from an electronic table of types of goods and services tax rates upon the computer system of said processor;
calculating sales taxes due using a selected tax rate applied to said retail sales information upon the computer system of said processor and filing of documents with a collecting government agency, and calculating commission due said processor;
dividing sales taxes from sales revenue and commission due said processor from sales revenue upon the computer system of said processor; and,
depositing sales taxes with a collecting government agency and sales revenue with a merchant by the computer system of said processor in a timely manner.

11. The method of dividing sales taxes from sales revenue of claim 10 further comprising:
said calculating sales taxes excluding tips.

12. The method of dividing sales taxes from sales revenue of claim 10 wherein said depositing sales taxes with a collecting government agency and sales revenue with said merchant occurs within forty eight hours of a retail sale.

13. The method of dividing sales taxes from sales revenue of claim 10 wherein said depositing sales taxes with a collecting government agency and sales revenue with said merchant occurs within twenty four hours of a retail sale.

14. The method of dividing sales taxes from sales revenue of claim 10 wherein said depositing sales taxes with a collecting government agency and sales revenue with said merchant occurs within eight hours of a retail sale.
